(19) United States
(12) Patent Application Publication
(10) Pub. No.: US 2025/0238021 A1
(43) Pub. Date: Jul. 24, 2025

(54) Method for Operating a Networked IoT Device in an Automation Network, IoT Device, and Automation Network

(71) Applicant: Siemens Aktiengesellschaft, München (DE)

(72) Inventors: Steffen Fries, Baldham (DE); Rainer Falk, Erding (DE); Stefan Becker, Adelsdorf (DE); Tobias Greiten, Baiersdorf (DE); Maximilian Hoch, Adelsdorf (DE); Gunther Birk, Erlangen/Buckenhof (DE)

(73) Assignee: Siemens Aktiengesellschaft, München (DE)

(21) Appl. No.: 18/852,589

(22) PCT Filed: Mar. 14, 2023
(86) PCT No.: PCT/EP2023/056447

§ 371 Date: Sep. 30, 2024

(30) Foreign Application Priority Data
Mar. 31, 2022 (EP) 22165878.4

(51) Int. Cl. G05B 19/418; G16Y 40/50

(52) U.S. Cl. CPC G05B 19/4184; G05B 19/4185; G16Y 40/50

(57) ABSTRACT

Various embodiments of the teachings herein include a method for operating a networked IoT device in an automation network with an application and with a security guideline implemented on the IoT device with a security specification. An example includes: selecting a security function for the application on the basis of a device state of the IoT device; and operating the IoT device with the application with the security function.

### CROSS-REFERENCE TO RELATED APPLICATIONS

This application is a U.S. National Stage Application of International Application No. PCT/EP2023/056447 filed Mar. 14, 2023, which designates the United States of America, and claims priority to EP Application No. 22165878.4 filed Mar. 31, 2022, the contents of which are hereby incorporated by reference in their entirety.

### TECHNICAL FIELD

The present disclosure relates to the Internet of Things (IoT). Various embodiments of the teachings herein include methods and/or systems for operating a networked IoT device in an automation network with at least one application.

### BACKGROUND

In information technology (IT) environments, for instance in digitized office environments, in servers, or in computing centers, it is typical practice to configure security guidelines and to implement them on terminals each managed by means of a network. These security guidelines specify, for instance, which methods can be used for network authentication, which root certificates are recognized or whether and how an application can interact with other network components. In this case, on the one hand, IT security is at the forefront. On the other hand, the terminals in question are typically not restricted, with the result that an additional load caused by the encryption of a connection is of no consequence.

In industrial environments, that is to say in the field of “Operation Technology” (OT) or the “Industrial Internet of Things” (IIoT), it is often not possible to accordingly enforce a security policy during ongoing operation of an installation since a security measure that is specified by a security guideline could impair the operation of the installation. Impairments may affect the regular process, for example as a result of delays in processes and even total failure. Influences on the safety of an installation are likewise possible, with the result that there may be dangers for the operating personnel.

### SUMMARY

The teachings of the present disclosure include improved methods and/or systems for operating a networked IoT device in an automation network, which does not have the above-mentioned disadvantages, in particular. For example, some embodiments include a method for operating a networked IoT device (IIOTC) in an automation network (AN) with at least one application (APP) and with at least one security guideline which is implemented on the IoT device (IIOTC) and has at least one security specification, in which at least one security function is selected (EVALSESCMEAS) for the at least one application on the basis of a device state of the IoT device (IIOTC), and in which the IoT device (IIOTC) is operated with the application with the at least one security function.

In some embodiments, the IoT device (IIOTC) is a manufacturing device or a maintenance device or an open-loop and/or closed-loop control device for a manufacturing device or a maintenance device or a monitoring device for a manufacturing device or a maintenance device.

In some embodiments, the device state comprises an operating state of the IoT device (IIOTC).

In some embodiments, the device state is an operating state of the IoT device (IIOTC) for performing a current work step of the IoT device (IIOTC) or comprises such an operating state of the IoT device for performing a current work step of the IoT device (IIOTC), wherein the work step is preferably a manufacturing step or a maintenance step or an open-loop and/or closed-loop control step for controlling a manufacturing step or a maintenance step or a monitoring step for monitoring a manufacturing step or a maintenance step.

In some embodiments, the device state is or comprises a communication environment of the IoT device (IIOTC), in particular a signal connection of the IoT device (IIOTC).

In some embodiments, the device state comprises a resource utilization, in particular a memory utilization and/or a processor utilization.

In some embodiments, the at least one security function is selected on the basis of the device state from a database or from a configurable list of two or more security measures.

In some embodiments, the database has a specific security function for the IoT device (IIOTC).

In some embodiments, the database has a specific security function for a device class of the IoT device (IIOTC).

In some embodiments, the security measure is selected (EVALSESCMEAS) when the IoT device (IIOTC) is started and/or when the application is started and/or at repeatedly successive, in particular regular, intervals of time.

In some embodiments, the security function has specifications for authentication with communication partners of the IoT device (IIOTC) and/or specifications for security protocols and/or specifications for monitoring communication connections.

As another example, some embodiments include a computer program product for carrying out a method as described herein when it is executed on an IoT device (IIOTC), which has an input interface for information relating to the device state, a database having at least two security functions for operating at least one application, and at least one selection component for selecting a security function for the application on the basis of the information relating to the device state, and an enforcement component for enforcing the security function.

As another example, some embodiments include a IoT device designed to carry out one or more of the methods described herein, having at least one application (APP) which is implemented on the IoT device (IIOTC) and having at least one security guideline which is implemented on the IoT device (IIOTC) and has at least one security function, in which the at least one security function can be activated for the at least one application on the basis of a device state of the IoT device (IIOTC), and in which the IoT device (IIOTC) is designed to be operated with the application with the at least one security function, wherein the IoT device is, in particular, a manufacturing device or a maintenance device or an open-loop or closed-loop control device for a manufacturing device or a maintenance device or a monitoring device for a manufacturing device or a maintenance device.

As another example, some embodiments include an automation network having at least one IoT device (IIOTC), in which the automation network is designed to carry out one or more of the methods described herein and/or at least one, a plurality of or all of the at least one IoT device (IIOTC) is/are an IoT device (IIOTC) as as described herein.

In some embodiments, the automation network is a manufacturing network or a maintenance network.

### BRIEF DESCRIPTION OF THE DRAWINGS

The teachings of the present disclosure are explained in more detail below using an exemplary embodiment which is illustrated in the drawing, in which:

FIG. 1 shows a schematic diagram of an example automation network having IoT devices incorporating teachings of the present disclosure for carrying out methods incorporating teachings of the present disclosure; and

FIG. 2 shows a flowchart of an example method incorporating teachings of the present disclosure.

### DETAILED DESCRIPTION

Some teachings of the present disclosure include methods for operating a networked IoT device in an automation network with at least one application running on the IoT device and with at least one security guideline which is implemented on the IoT device and has at least one security function. At least one security function is selected for the at least one application on the basis of a device state of the IoT device in a productive process and the IoT device is operated with the application with the at least one security function.

The methods described herein can also be used in industrial environments, that is to say in the field of Operation Technology (OT) and the Industrial Internet of Things (also referred to as IIoT), to enforce a security guideline having the at least one dynamically determined security function, since the consideration of the device state makes it possible to operate the networked IoT device continuously and without danger. Consequently, dynamically determined security functions can also be used in OT and/or IIoT environments without the productivity or the reliable operation of the OT or IIoT environment being impaired. The methods may be used to operate industrial IoT devices. Regular IT security scanning can also be carried out in industrial environments using the methods.

The terms “security guideline” and “security function” are terms from security in the sense of IT security. A security guideline means, in particular, a set of one or more security rules, which are also known as a “security policy”. A security function is understood as meaning a “security functionality”.

The methods described herein may make it possible to provide a tiered security guideline which allows a security function—at least one security function—that is adapted to the respective device state and can also be reliably used in OT and/or IIoT environments that are critical to operation.

In some embodiments, the IoT device is a manufacturing device or a maintenance device or an open-loop or closed-loop control device for a manufacturing device or a maintenance device or a monitoring device for a manufacturing device or a maintenance device.

The field of manufacturing, in particular digital manufacturing, and maintenance, in particular, is formed by security-critical environments in which either secure operation as previously known is possible by means of the method according to the invention or a predefined degree of security can be achieved in manufacturing or maintenance during ongoing operation since the implementation of the security guidelines does not require any manual adaptation of the security guidelines and possibly an interruption in manufacturing or maintenance, but rather can be carried out in an automated manner in the productive process on the basis of automated detection of the current device state.

In some embodiments, the device state comprises an operating state of the IoT device, in particular an operating state for performing a current work step of the IoT device, or the device state is the operating state of the IoT device. In particular, the operating state of the IoT device is an important parameter for implementing a security guideline since computing resources, for example for encrypted communication by means of an application configured for communication or for monitoring the security of an application, are or are not available depending on the operating state of the IoT device. In addition, different privileges are regularly available for applications depending on the operating state of the device, for instance in an update mode for updating software of the IoT device or in a maintenance state for maintaining the IoT device.

In some embodiments, the operating state of the IoT device for performing a current work step of the IoT device depends on this work step, that is to say the work step performed identifies or defines precisely this operating state of the IoT device. The operating state therefore differs from other operating states of the IoT device in the respectively performed work steps. The work step may be a manufacturing step or a maintenance step and the IoT device may be a manufacturing device or a maintenance device.

In some embodiments, the current work step may be an open-loop and/or closed-loop control step for controlling a manufacturing step or a maintenance step, wherein the IoT device is preferably an open-loop and/or closed-loop control device, or a monitoring step for monitoring a manufacturing step or a maintenance step. In some embodiments, in the last case, the IoT device is a monitoring device.

In some embodiments, the device state comprises a communication environment of the IoT device, in particular a signal connection of the IoT device. In particular, one or more security functions with a different degree of security may be designed depending on the communication environment of the IoT device. A different, usually lower, security standard can thus be used for isolated communication within the automation network than for external communication that leads into or out of the automation network.

In some embodiments, the device state comprises a resource utilization, in particular a memory utilization and/or a processor utilization. The resource utilization is a particularly relevant parameter since the at least one security function often requires a specific, relative portion or a specific, absolute quantity of resources, for instance available memory or available computing power, for secure operation. If the resource utilization is too high on account of the at least one security function that is additionally added, IT security may be preserved, but the functional security of the IoT device may be disrupted. In contrast, in this development of the method according to the invention, functional security can be reliably preserved.

In some embodiments, the at least one security function is selected on the basis of the device state from a database or from a configurable list of two or more security functions. At least two security functions which allow dynamic adaptation of the security functions on the basis of the device state are therefore available for a tiered security guideline.

In some embodiments, the database has two or more specific security functions for the IoT device. In some embodiments, the database has two or more specific security functions for a device class of the IoT device.

In some embodiments, the security measure is selected when the IoT device is started and/or when the application is started and/or at repeatedly successive, in particular regular, intervals of time. In this development, continuous and continued dynamic adaptation of the security function is possible.

In some embodiments, the security function has specifications for authentication with communication partners of the IoT device and/or specifications for security protocols and/or specifications for monitoring communication connections. Security of the method according to the invention may be significantly increased by means of the above-mentioned security functions.

In some embodiments, a computer program product is designed to carry out one or more of the methods as explained above when it is executed on an IoT device. In this case, the computer program product has an input interface for information relating to the device state and a database having at least two security functions for operating at least one application, and at least one selection component for selecting a security function for the application on the basis of the information relating to the device state, and an enforcement component for enforcing the security function. In this development, the methods can consequently be carried out in a computer-implemented and automated manner without manual intervention and therefore in a particularly efficient manner.

In some embodiments, an IoT device is designed to carry out one or more of the methods as described above and has, in particular, a computer program product as described above. The IoT device has at least one application which is implemented on the IoT device and at least one security guideline which is implemented on the IoT device and has at least one security function, wherein the at least one security function can be activated for the at least one application on the basis of a device state of the IoT device, and wherein the IoT device is designed to be operated with the application with the at least one security function. The same advantages as already described for the methods arise for the IoT devices. The features optionally described in the description of the methods may be implemented, if feasible, for the IoT devices, too. The above-described advantages likewise arise in these developments.

In some embodiments, the IoT device is a manufacturing device or a maintenance device or an open-loop or closed-loop control device for a manufacturing device or a maintenance device or a monitoring device for a manufacturing device or a maintenance device. In this development, the IoT device may be an industrial IIoT device and/or an IoT device in an OT environment.

In some embodiments, an automation network has at least one IoT device as described above. The automation network is designed to carry out one or more of the methods as described above and/or at least one, a plurality of or all of the at least one IoT device is/are an IoT device as described above.

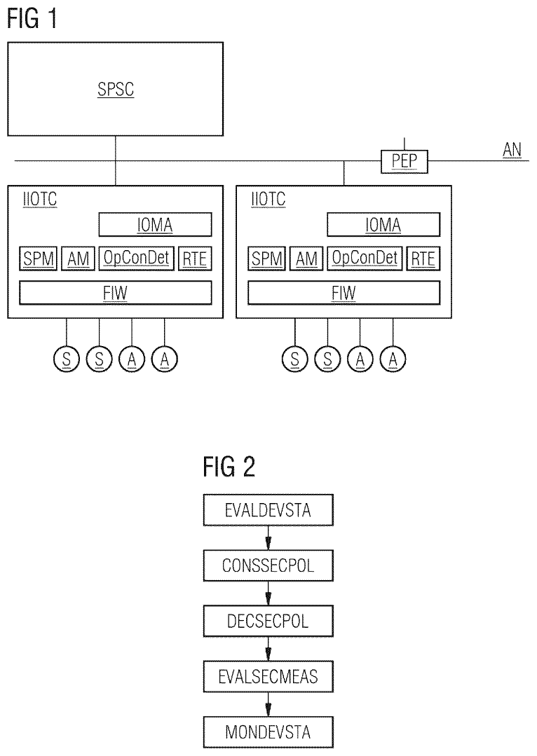

The two IIoT (Industrial Internet of Things) components IIOTC illustrated in FIG. 1 each form networked manufacturing devices which are each incorporated in an automation network AN by means of signal connections. In the embodiment illustrated, these IIoT components IIOTC have various sensors S and actuators A. The sensors S provide information which is used, on the one hand, directly to control the actuators A of those IIoT components IIOTC, to which the sensors S each belong. This is effected using an I/O module application IOMA which runs on the respective IIoT component IIOTC in a runtime environment RTE embedded in firmware FIW. The sensor information is forwarded at the same time to further IIoT components IIOTC which use this information to control their locally connected actuators A.

For each locally installed I/O module application IOMA and for further applications which run on the IIoT components IIOTC, an application manager AM is used to provide a security guideline, that is to say a security policy, which is managed by the security policy manager SPM. Security-relevant boundary conditions for implementing various security mechanisms for one of the above-mentioned applications or for a group of applications are defined in the security guideline. The current utilization of the local resources, that is to say resources managed by the respective IIoT component IIOTC, here storage space and available CPU time, as well the current operating state of the component are transmitted to the security policy manager SPM by an additional function “operational condition detector” OpConDet, with the result that the security policy manager SPM determines the respective security measures on the basis of the resource utilization by means of the security guidelines. The operating state of the IIoT component IIOTC, which determines the respective security guideline, and the resource utilization, which determines the respective security measures on the basis of the respectively determined security guideline, together form the device state of the IIoT component IIOTC in the sense of the present application.

In the present case, the security policy manager SPM can determine a security guideline of the IIoT component for possible operating states of the IIoT component IIOTC and for each individual application. The operating state of the IIoT component IIOTC is first of all determined by means of a determination step EVALDEVSTA (see FIG. 2).

In order to select a security guideline for the respective application, the security policy manager uses an assignment table to perform an assignment step CONSSECPOL. The assignment table contains, for each application, an assignment of operating states and security guidelines, with the result that a security guideline can be assigned to each operating state determined by means of the determination step EVALDEVSTA using the assignment step CONSSECPOL. For this purpose, the assigned security guideline is selected on the basis of the determined operating state and is stipulated by means of a stipulation step DECSECPOL. The security guidelines stipulate respectively provided security measures on the basis of predefined absolute and relative limit values for the respective resource utilization, that is to say for the memory utilization and the available CPU time.

The security measures are therefore stipulated in an automated manner for the IIoT components IIOTC on the basis of a device state characterized by the respective resource utilization and the respective operating state. Each security guideline in the assignment table that is held in the security policy manager SPM now stipulates which security mechanisms are possible locally, for example when opening a communication connection or locally authenticating a user, on the basis of the operating state and the resource utilization of the IIoT component IIOTC.

In the embodiment illustrated, the security guidelines contain an assignment to the respective application, for which the respective security guideline is valid, and, for the respective application, an indication of the dependence on the respective boundary conditions, in the embodiment illustrated the dependence of the respective security measures on the currently available memory and the current processor load and the manufacturing step respectively performed by the IIoT component IIOTC and the currently used communication protocol.

The security measures stipulated in the security guideline are now stipulated on the basis of the current boundary conditions, that is to say the current resource utilization, in accordance with the security guideline in a security measure stipulation step EVALSECMEAS.

In the embodiment illustrated, neither the resource utilization nor the respective operating state of the IIoT component IIOTC is constant, but rather also depends on applications currently running on the respective IIoT component IIOTC and a manufacturing step currently being performed by the IIoT component IIOTC. Therefore, the respective device state of the IIoT component IIOTC is monitored by means of the monitoring step MONDEVSTA. If the operating state of the IIoT component IIOTC or the resource utilization of the IIoT component IIOTC changes, the security guideline is adapted on the basis of the operating state and the security measure respectively provided in the security guideline is adapted on the basis of the resource utilization.

In addition, the security guideline respectively contains a preset security measure for the respective application for authentication for local access and/or remote access and for the protection of the integrity or confidentiality of the communication with other IIoT components IIOTC and for authorizing access to the application or for authorizing the application, wherein the preset security measure provides, on the basis of the respective resource utilization, alternative security measures which take the place of the preset security measure, wherein the alternative security measures provide for extended local logging and involvement of a security guideline support component SPSC available in the automation network AN by means of address information laid down in the security guideline and relating to the security guideline support component SPSC which is designed to monitor the respective application on the respective IIoT component IIOTC.

In addition, the security guideline provides for information relating to the use of weaker security mechanisms of the respective IIoT component IIOTC to be transmitted to an edge component or IIoT components IIOTC signal-connected to the IIoT component IIOTC in question for the purpose of exchanging data. This information can be taken into account by the signal-connected edge component or the signal-connected IIoT components IIOTC during data evaluation by the signal-connected edge component or the signal-connected IIoT components IIOTC.

Furthermore, security measures can be enforced in a security guideline enforcement module PEP. For example, it is thus possible to prevent external communication with the IIoT component IIOTC in question from being directly set up if the security measure requires end-to-end security. In this case, communication can be set up, via the security guideline support component SPSC, as a proxy which can then implement the necessary security mechanisms instead of the IIoT component IIOTC.

A list of security guidelines (left-hand column) on the basis of an operating state (central column) of the respective IIoT component IIOTC is stated below by way of example for a respective application. In this case, the security guidelines each comprise individually specific dependences (right-hand column) on a resource utilization of the respective IIoT component IIOTC and further dependences, as respectively indicated for the security guideline.

| | | Specific dependence on a |
|---|---|---|
| | | resource utilization and |
| Security guideline | Operating state | further dependences |
| Certificate-based | Operative use | Authentication and |
| authentication in | | certificate validation |
| the context of a | | allowed if: |
| security protocol | | the processor has a |
| | | load of at most 60% and |
| | | free memory of at |
| | | least 50 kB is available |
| | | no critical |
| | | (safety-relevant) |
| | | manufacturing step is |
| | | carried out |
| | | Authentication (fewer |
| | | requirements) allowed |
| | | if: |
| | | the processor has a |
| | | load of at most 80% and |
| | | free memory of at |
| | | least 20 kB is available |
| | | no critical |
| | | manufacturing step is |
| | | carried out |
| | | the certificate |
| | | validation (including |
| | | revocation status) must |
| | | be delegated to an |
| | | external component. |
| | | If no authentication is |
| | | possible locally, but |
| | | the connection must be |
| | | set up: |
| | | transmit |
| | | information to a |
| | | monitoring component in |
| | | order to strictly |
| | | monitor the connection |
| | | use integrity |
| | | protection methods (no |
| | | confidentiality) in |
| | | order to enable passive |
| | | monitoring. |
| | Maintenance | Always |
| Updating of | Operative use | Allowed if no critical |
| session keys | | manufacturing step is |
| | | carried out |
| | Maintenance | Always |
| Set-up of unencrypted | Operative use | Allowed under increased |
| connections to | | monitoring requirements |
| local network | | transmit |
| devices | | information to a |
| | | monitoring component in |
| | | order to strictly |
| | | monitor the connection. |
| | Maintenance | Connection set-up |
| | | allowed only to the FW |
| | | update server (under the |
| | | boundary condition that |
| | | the firmware is |
| | | protected independently |
| | | of transport (for |
| | | example using a digital |
| | | signature) |
| Set-up of | Operative use | Authentication and |
| encrypted | | certificate validation |
| connections to | | allowed if: |
| local network | | the processor has a |
| devices | | load of at most 60% and |
| | | free memory of at |
| | | least 50 kB is available |
| | | no critical |
| | | manufacturing step is |
| | | carried out |
| | | Authentication allowed |
| | | if: |
| | | the processor has a |
| | | load of at most 80% and |
| | | free memory of at |
| | | least 20 kB is available |
| | | no critical |
| | | manufacturing step is |
| | | carried out |
| | | the certificate |
| | | validation (including |
| | | revocation status) must |
| | | be delegated to an |
| | | external component. |
| | | If no authentication is |
| | | possible locally, but |
| | | the connection must be |
| | | set up: |
| | | transmit |
| | | information to a |
| | | monitoring component in |
| | | order to strictly |
| | | monitor the connection |
| | | use integrity |
| | | protection methods (no |
| | | confidentiality) in |
| | | order to enable passive |
| | | monitoring. |
| | Maintenance | Connection set-up only |
| | | to the |
| | | device management |
| | | server |
| | | configuration server |
| | | FW update server |
| Application update | Operative use | Never |
| | Maintenance | Always |

In further embodiments which are not specifically illustrated, the IIoT component IIOTC is an open-loop and/or closed-loop control device, wherein an open-loop and/or closed-loop control step for controlling a manufacturing step can take the place of the respective manufacturing step or the IIoT component IIOTC is a monitoring device for monitoring a manufacturing step. In the last case, the IIoT component IIOTC may be a monitoring device. Instead of the respective manufacturing step, a maintenance step may also respectively occur in the aforementioned embodiments.

What is claimed is:

1. A method for operating a networked IoT device in an automation network with an application and with a security guideline implemented on the IoT device with a security specification, the method comprising:
selecting a security function for the application on the basis of a device state of the IoT device; and
operating the IoT device with the application with the security function.

2. The method as claimed in claim 1, wherein the IoT device comprises: a manufacturing device, a maintenance device, an open-loop, and/or closed-loop control device for: a manufacturing device, a maintenance device, or a monitoring device for a manufacturing device or a maintenance device.

3. The method as claimed in claim 1, wherein the device state comprises an operating state of the IoT device.

4. The method as claimed in claim 1, wherein:
the device state comprises an operating state of the IoT device for performing a current work step of the IoT device; and
the work step comprises: a manufacturing step, a maintenance step, an open-loop control step, and/or a closed-loop control step for controlling: a manufacturing step, a maintenance step, or a monitoring step for monitoring a manufacturing step or a maintenance step.

5. The method as claimed in claim 1, wherein the device state comprises a communication environment of the IoT device.

6. The method as claimed in claim 1, wherein the device state comprises a resource utilization.

7. The method as claimed in claim 1, wherein the security function is selected from a database or from a configurable list of two or more security measures.

8. The method as claimed in claim 1, wherein the database has a specific security function for the IoT device.

9. The method as claimed in claim 1, wherein the database has a specific security function for a device class of the IoT device.

10. The method as claimed in claim 1, wherein the security measure is selected when the IoT device is started and/or when the application is started and/or at repeatedly successive intervals of time.

11. The method as claimed in claim 1, wherein the security function has specifications for authentication with communication partners of the IoT device and/or specifications for security protocols and/or specifications for monitoring communication connections.

12. A set of computer program instructions stored on a non-transitory medium, the set of instructions when executed on an IoT device, providing the IoT device:
an input interface for information relating to the device state;
a database having two security functions for operating an application;
a selection component for selecting a security function for the application on the basis of the information relating to the device state; and
an enforcement component for enforcing the security function.

13. An IoT device comprising:
a set of computer program instructions stored on a non-transitory medium, the set of instructions when executed on an IoT device, providing the IoT device:
an input interface for information relating to the device state;
a database having two security functions for operating an application;
a selection component for selecting a security function for the application on the basis of the information relating to the device state; and
an enforcement component for enforcing the security function;
wherein the IoT device comprises: a manufacturing device, a maintenance device, an open-loop control device, or a closed-loop control device for a manufacturing device or a maintenance device or a monitoring device for a manufacturing device or a maintenance device.

14-15. (canceled)
